(19) United States
(12) Patent Application Publication
(10) Pub. No.: US 2005/0103390 A1
(43) Pub. Date: May 19, 2005

(54) Hydraulic unit of anti-lock brake system and method of manufacturing the same

(75) Inventors: I - Jin Yang, Pyungtak-Si (KR); Dong- Hun Ha, Pyungtak-Si (KR)

Correspondence Address: Richard P. Berg;c/o LADAS & PARRY, Suite 2100, 5670 Wilshire Boulevard, Los Angeles, CA, 90036-5679, US

(73) Assignee: MANDO CORPORATION

(21) Appl. No.: 10/977,728

(22) Filed: Oct. 29, 2004

(30) Foreign Application Priority Data
Nov. 14, 2003 (KR) 2003-80666

(51) Int. Cl. F17D 1/00

(52) U.S. Cl. 137/884

(57) ABSTRACT

The present invention discloses a hydraulic unit of an anti-lock brake system for vehicles having a housing that is easily manufactured, whereby production efficiency is improved, and thus the manufacturing costs of the housing are reduced. The present invention also discloses a method of manufacturing the same. The hydraulic unit comprises a housing having components that control braking oil pressure supplied to wheels of a vehicle, such as a plurality of valves, accumulators, and hydraulic pumps, mounted thereto, flow channels formed in the housing, the flow channels being connected between the components, and a plurality of pipes connected to each other in the housing. The components are provided at the outer surfaces of the positions where the components are mounted to the housing with reinforcing parts. The reinforcing parts are formed through injection molding of a resin material. The housing is provided with a plurality of bores corresponding to the reinforcing parts of the components. The bores are formed through injection molding of a resin material. The reinforcing parts of the components are fitted in the bores, respectively.

### CROSS-REFERENCE TO RELATED APPLICATION

This application claims the benefit of Korean Patent Application No. 2004-80666, filed on Nov. 14, 2004 in the Korean Intellectual Property Office, the disclosure of which is incorporated herein by reference.

### BACKGROUND OF THE INVENTION

1. Field of the Invention

The present invention relates to a hydraulic unit of an anti-lock brake system for vehicles, and, more particularly, to a hydraulic unit of an anti-lock brake system that is manufactured through injection molding of a resin material. Also, the present invention relates to a method of manufacturing the same.

2. Description of the Related Art

An anti-lock brake system mounted in a vehicle is a system that controls braking oil pressure applied to wheel cylinders of wheels of the vehicle such that the braking oil pressure is decreased or increased when the vehicle is braked. The wheel of the vehicle is not fully locked by means of the anti-lock brake system, whereby the vehicle is stopped within the shortest distance possible while the steering performance of the vehicle is maintained. Such an anti-lock brake system further comprises a hydraulic unit that controls braking oil pressure, an electronic control unit that controls the hydraulic unit, and wheel sensors that sense velocities of the respective wheels of the vehicle, in addition to a servomechanism, a master cylinder, and wheel cylinders of a common brake system for vehicles.

The hydraulic unit of the anti-lock brake system decreases, maintains, or increases braking oil pressures applied to the wheels of the vehicle to control the braking force. One example of the hydraulic unit of the anti-lock brake system is disclosed in U.S. Pat. No. 5,577,813 wherein the hydraulic unit of the anti-lock brake system comprises a block-type housing having a plurality of flow channels formed therein, a plurality of valves mounted to the housing for opening/closing the flow channels, a pump that pressurizes a fluid, and low-pressure and high-pressure accumulators that accumulate the fluid.

To manufacture the conventional hydraulic unit as described above, a metal material, such as aluminum, is cut to obtain a hexahedral housing, and then the housing is also cut to form a plurality of bores and a plurality of inner flow channels in the housing. In the block-type housing manufactured as described above are mounted a plurality of valves, a pump, and low-pressure and high-pressure accumulators. In this way, the hydraulic unit is manufactured.

In the conventional hydraulic unit of the anti-lock brake system, however, the aluminum housing is manufactured through a cutting step of cutting the housing such that the surface of the housing is flat, another cutting step of forming bores, in which a plurality of components are mounted in the housing, and yet another cutting step of forming inner flow channels in the housing. It is necessary that high-accuracy cutting operations be carried out at the respective cutting steps. As a result, the manufacturing process of the housing is very complicated and troublesome. Furthermore, the manufacturing costs of the housing are very high, since the housing is made of aluminum.

### SUMMARY OF THE INVENTION

Therefore, it is an aspect of the invention to provide a hydraulic unit of an anti-lock brake system for vehicles having a housing that is easily manufactured, whereby production efficiency is improved, and thus the manufacturing costs of the housing are reduced.

It is another aspect of the invention to provide a method of manufacturing the same.

In accordance with one aspect, the present invention provides a hydraulic unit of an anti-lock brake system, the hydraulic unit comprising a housing having components that control braking oil pressure supplied to wheels of a vehicle, such as a plurality of valves, accumulators, and hydraulic pumps, mounted thereto, flow channels formed in the housing, the flow channels being connected between the components, and a plurality of pipes connected to each other in the housing, wherein the components are provided at the outer surfaces of the positions where the components are mounted to the housing with reinforcing parts, the reinforcing parts being formed through injection molding of a resin material, and the housing is provided with a plurality of bores corresponding to the reinforcing parts of the components, the bores being formed through injection molding of a resin material, the reinforcing parts of the components being fitted in the bores, respectively.

In accordance with another aspect, the present invention provides a method of manufacturing a hydraulic unit of an anti-lock brake system, the hydraulic unit comprising a housing having components that control braking oil pressure supplied to wheels of a vehicle, such as a plurality of valves, accumulators, and hydraulic pumps, mounted thereto, flow channels formed in the housing, the flow channels being connected between the components, and a plurality of pipes connected to each other in the housing, wherein the method comprises: a reinforcing part manufacturing step of manufacturing reinforcing parts to be fitted on the outer surfaces of the components through injection molding; a housing manufacturing step of manufacturing a housing provided with a plurality of bores having a size corresponding to that of the reinforcing parts through injection molding using a mold; and a component mounting step of mounting components with the reinforcing parts to the housing.

Preferably, the reinforcing part manufacturing step is carried out such that the reinforcing parts are formed while the components are placed in molds used to form the reinforcing parts, whereby the reinforcing parts are formed integrally with the components, respectively.

Preferably, the reinforcing part manufacturing step comprises the sub-steps of: separately forming the reinforcing parts using molds; and fitting the reinforcing parts on the outer surfaces of the components, respectively.

Preferably, the housing manufacturing step is carried out such that the bores and the flow channels are simultaneously formed.

Preferably, the component mounting step is carried out such that bonding agents are applied to the outer surfaces of the reinforcing parts, and then the reinforcing parts are forcibly fitted into the bores of the housing, respectively.

Preferably, the reinforcing part manufacturing step comprises the sub-steps of: forming thread parts at the outer surfaces of the reinforcing parts, and the housing manufacturing step comprises the sub-steps of: forming thread parts at the: inner surfaces of the bores of the housing, the thread parts of the bores of the housing corresponding to those of the reinforcing parts, whereby the reinforcing parts are fitted into the bores of the housing by the thread engagement between the reinforcing parts and the bores of the housing.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings, of which:

FIG. 1 is a view showing a hydraulic circuit of an anti-lock brake system according to the present invention;

FIG. 2 is an exploded perspective view showing the structure of a hydraulic unit of the anti-lock brake system according to the present invention shown in FIG. 1;

FIG. 3 is a perspective view showing bores and flow channels formed in a housing of the hydraulic unit of the anti-lock brake system according to the present invention shown in FIG. 1;

FIG. 4 is a sectional view taken along line IV-IV′ of FIG. 2;

FIG. 5 is a flow chart illustrating a manufacturing process of a hydraulic unit of an anti-lock brake system according to a preferred embodiment of the present invention; and

FIG. 6 is a flow chart illustrating a manufacturing process of a hydraulic unit of an anti-lock brake system according to another preferred embodiment of the present invention.

### DETAILED DESCRIPTION OF THE PREFERRED EMBODIMENTS

Reference will now be made in detail to the embodiment of the present invention, examples of which are illustrated in the accompanying drawings, wherein like reference numerals refer to like elements throughout. The embodiment is described below to explain the present invention by referring to the figures.

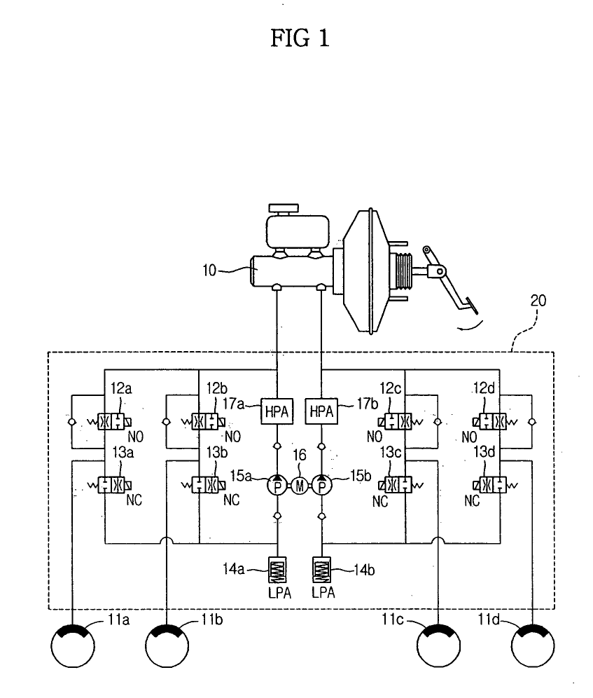

FIG. 1 is a view showing a hydraulic circuit of an anti-lock brake system according to the present invention. As is shown in FIG. 1, the anti-lock brake system comprises: a plurality of valves 12a, 12b, 12c, 12d, 13a, 13b, 13c, and 13d that intermittently control transmission of braking oil pressure created in a master cylinder 10 to wheel cylinders 11a, 11b, 11c, and 11d mounted to front and rear wheels of the vehicle, respectively; and two low-pressure accumulators 14a and 14b that accumulate oil returned from the wheel cylinders 11a, 11b, 11c, and 11d. The anti-lock brake system further comprises: two hydraulic pumps 15a and 15b that pressurize oil accumulated in the low-pressure accumulators 14a and 14b; a motor 16 that operates the hydraulic pumps 15a and 15b; and two high-pressure accumulators 17a and 17b that accumulate oil discharged from the hydraulic pumps 15a and 15b to decrease pressure pulsation.

The plurality of valves in the hydraulic circuit of FIG. 1 comprise: normal open type valves 12a, 12b, 12c, and 12d, which are disposed upstream of flow channels connected to the wheel cylinders 11a, 11b, 11c, and 11d of the wheels, respectively, the normal open type valves 12a, 12b, 12c, and 12d being normally open; and normal closed type valves 13a, 13b, 13c, and 13d, which are disposed downstream of flow channels connected to the wheel cylinders 11a, 11b, 11c, and 11d of the wheels, respectively, the normal open type valves 12a, 12b, 12c, and 12d being normally open. The two hydraulic pumps 15a and 15b are common piston-type pumps, which are operated by means of the motor 16. The two low-pressure accumulators 14a and 14b are disposed at the flow channels at the inlet sides of the hydraulic pumps 15a and 15b for accumulating oil returned from the normal closed type valves 13a, 13b, 13c, and 13d and supplying the accumulated oil to the inlets of the hydraulic pumps 15a and 15b. The two high-pressure accumulators 17a and 17b are disposed at the flow channels at the outlet sides of the hydraulic pumps 15a and 15b for accumulating oil discharged from the hydraulic pumps 15a and 15b to decrease pressure pulsation caused by the operation of the hydraulic pumps 15a and 15b. The operation of the motor 16, that drives the valves 12a, 12b, 12c, 12d, 13a, 13b, 13c, and 13d, and the hydraulic pumps 15a and 15b, is controlled by means of an electronic control unit (not shown) such that the braking oil pressure transmitted to the wheel cylinders of the wheels are controlled.

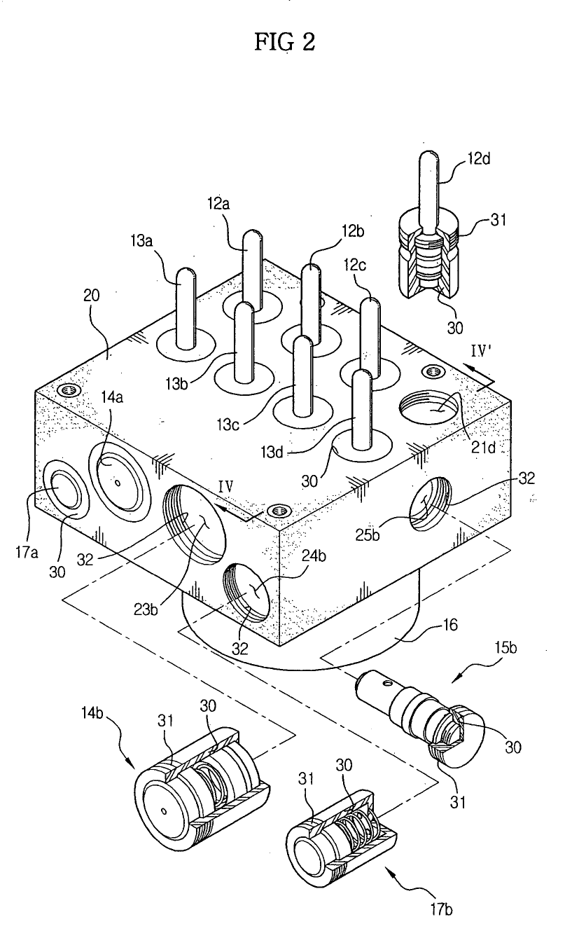

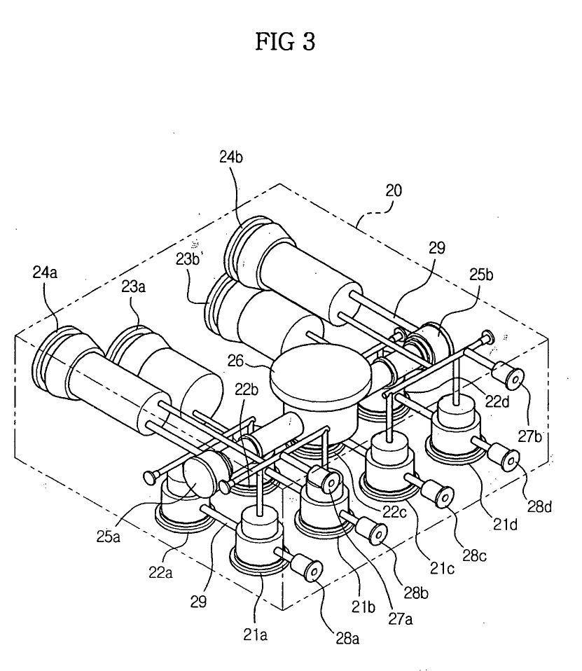

In the anti-lock brake system as described above, the plurality of valves 12a, 12b, 12c, 12d, 13a, 13b, 13c, and 13d, low-pressure and high-pressure accumulators 14a, 14b, 17a, and 17b, and hydraulic pumps 15a and 15b are mounted to a hexahedral housing 20 as is shown in FIG. 2 to form a hydraulic unit. As is shown in FIG. 3, the housing 20 of the hydraulic unit is provided with bores 21a, 21b, 21c, 21d, 22a, 22b, 22c, and 22d, in which the valves 12a, 12b, 12c, 12d, 13a, 13b, 13c, and 13d are fitted, respectively, bores 23a, 23b, 24a, and 24b, in which the low-pressure and high-pressure accumulators 14a, 14b, 17a, and 17b are fitted, respectively, bores 25a, 25b, and 26, in which the hydraulic pumps 15a and 15b, and the motor 16 that drives the hydraulic pumps 15a and 15b are fitted, respectively, and a plurality of pipe-connecting parts 27a, 27b, 28a, 28b, 28c, and 28d. In the housing 20 is formed a plurality of flow channels 29 connected between the components mounted to the housing 20 and the pipe-connecting parts. In this way, the hydraulic unit as is shown in FIG. 1 is accomplished.

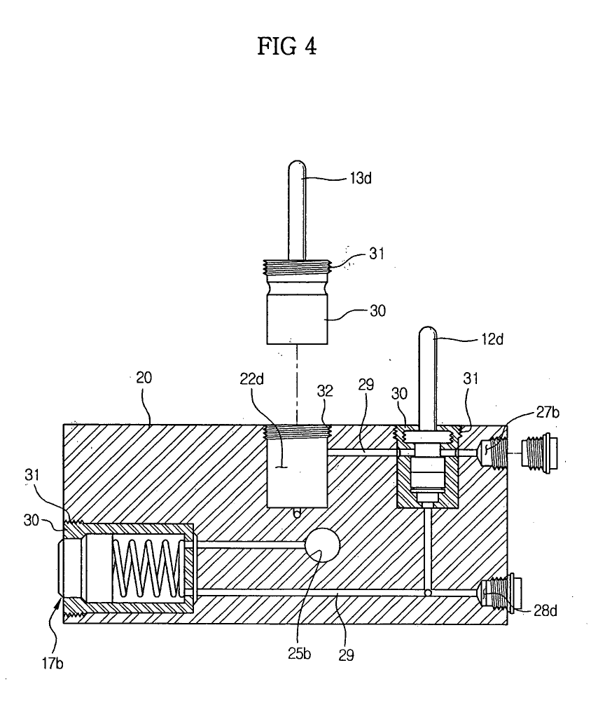

The housing 20 of the hydraulic unit according to the present invention is manufactured through injection molding of a resin material. Consequently, the housing 20 is easily manufactured. As is shown in FIGS. 2 and 4, reinforcing parts having a predetermined thickness are provided at the outer surfaces of the components mounted to the housing 20. The reinforcing parts are formed through injection molding. The housing 20 is provided with a plurality of bores having a size corresponding to that of the reinforcing parts 30 such that the reinforcing parts 30 provided at the components are mounted to the housing 20 in a cartridge-coupling fashion. Specifically, the reinforcing parts 30 are provided at the outer surfaces of the components mounted to the housing 20, and the reinforcing parts 30 are mounted to the housing 20. In this way, the bores of the housing 20 have a simplified shape, and thus the housing 20 is more easily manufactured through injection molding of a resin material. Also, the reinforcing parts 30 are provided at the outer surfaces of the components, whereby the components can be easily mounted to the housing 20, the strength of the positions where the components are mounted is increased, and airtightness at the positions where the components are mounted is maintained.

Now, a method of manufacturing the hydraulic unit of the anti-lock brake system with the above-stated construction according to the present invention will be described.

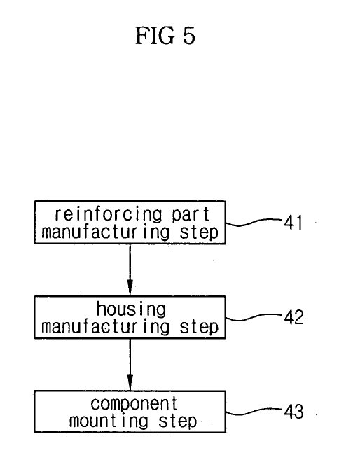

As is shown in FIG. 5, the method of manufacturing the hydraulic unit begins with step S41 of manufacturing the reinforcing parts 30, which are attached to the outer surfaces of the previously prepared components, such as the valves 12a, 12b, 12c, 12d, 13a, 13b, 13c, and 13d, the low-pressure and high-pressure accumulators 14a, 14b, 17a, and 17b, and the pumps 15a and 15b. The forming of the reinforcing parts 30 is carried out after the previously prepared components are placed in molds (not shown) that are used to form the reinforcing parts 30. In this way; the reinforcing parts 30 are formed integrally with the outer surfaces of the components as is shown in FIG. 2. Consequently, the reinforcing parts 30 are securely attached to the outer surfaces of the components while airtightness and watertightness between the reinforcing parts and the corresponding components are maintained although the outer shapes of the components are complicated. Preferably, the outer surfaces of the reinforcing parts 30 are formed in the shape of simple cylinders.

Subsequently, step S42 of forming a resin housing 20 through injection molding of a resin material is carried out in addition to the reinforcing part manufacturing step S41. Specifically, molten resin is injected into a mold (not shown) that is used to form the housing 20. After the resin housing forming step S42 is carried out, the plurality of bores, in which reinforcing parts 30 of the components will be fitted, are formed at the housing 20 by means of a plurality of cores (not shown) provided in the mold. Also, the flow channels 29 are formed in the housing 20 by means of flow channel-forming pins (not shown) disposed in the mold. At this time, the shape of the bores formed at the housing 29 is simplified corresponding to that of the reinforcing parts 30 provided at the outer surfaces of the components. Consequently, the housing 20 is easily formed.

Following the reinforcing part manufacturing step S41 and the resin housing forming step S42, step S43 of fitting the reinforcing parts 30 of the components into the bores of the housing 20 is carried out. The reinforcing parts 30 are forcibly fitted into the bores of the housing 20 while strong bonding agents are applied to the outer surfaces of the reinforcing parts 30 and the inner surfaces of the bores of the housing 20. Alternatively, the reinforcing parts 30 may be provided at the outer surfaces thereof with thread parts 31, and the bores of the housing 20 are provided at the inner surfaces thereof with thread parts 32 corresponding to the thread parts 31, as is shown in FIGS. 2 and 4, such that the reinforcing parts are fitted into the bores of the housing 20 by the thread engagement between the reinforcing parts 30 and the bores of the housing 20. In this case, the thread parts 31 and 32 are previously formed at the reinforcing part manufacturing step S41 and the resin housing forming step S42.

As described above, the housing 20 of the hydraulic unit is manufactured through injection molding. Consequently, the method of manufacturing the housing 20 of the hydraulic unit according to the present invention increases productivity and decreases the manufacturing costs as compared to the conventional method of manufacturing the housing through the aluminum cutting process. Also, the reinforcing parts 30 are provided at the outer surfaces of the components to be mounted to the housing 20, and the reinforcing parts 30 are fitted in the bores of the housing 20. Consequently, the shape of the bores of the housing 30 is simplified with the result that the housing 20 is more easily manufactured, and components are easily mounted to the housing 20.

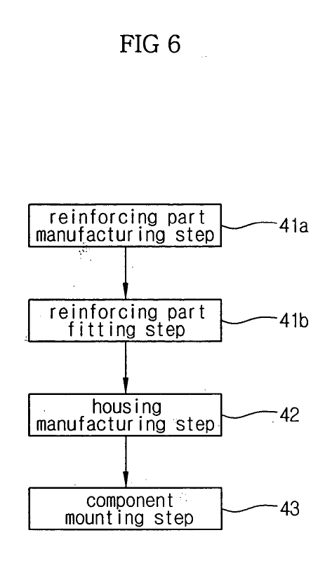

FIG. 6 is a flow chart illustrating a manufacturing process of a hydraulic unit of an anti-lock brake system according to another preferred embodiment of the present invention. This embodiment is identical to the previous embodiment shown in FIG. 5 except that the reinforcing parts 30 are separately formed and then attached to the outer surfaces of the components. Specifically, a reinforcing part manufacturing step S41a of manufacturing the reinforcing parts 30 through injection molding using molds used to form the reinforcing parts 30 is carried out, and then a reinforcing part attaching step 41b of attaching the reinforcing parts 30, which are manufactured at the reinforcing part manufacturing step S41a, on the outer surfaces of the components by forcible fitting or bonding agents is carried out. Other manufacturing steps of this embodiment are identical to those of the previous embodiment shown in FIG. 5, the description of which will not be given accordingly.

As apparent from the above description, the present invention provides a hydraulic unit of an anti-lock brake system for vehicles having a housing that is easily manufactured through injection molding of a resin material. Specifically, the housing is formed in a desired shape by carrying out the injection molding only once. Consequently, the present invention has the effect that the housing is easily manufactured with increased productivity as compared with the conventional method of manufacturing the housing through an aluminum cutting process.

Also, the reinforcing parts, which are previously prepared through injection molding, are attached to the outer surfaces of the components, which will be mounted to the housing, and the reinforcing parts are fitted in the bores of the housing. Consequently, the shape of the bores of the housing is simplified with the result that the housing can be easily formed, and the components can be easily mounted to the housing.

Furthermore, the housing is manufactured through injection molding of a resin material. Consequently, the manufacturing costs of the housing are considerably decreased as compared to the conventional hydraulic unit.

Although embodiments of the present invention have been shown and described, it would be appreciated by those skilled in the art that changes may be made in this embodiment without departing from the principles and spirit of the invention, the scope of which is defined in the claims and their equivalents.

1. A hydraulic unit of an anti-lock brake system, the hydraulic unit comprising a housing having components that control braking oil pressure supplied to wheels of a vehicle, such as a plurality of valves, accumulators, and hydraulic pumps, mounted thereto, flow channels formed in the housing, the flow channels being connected between the components, and a plurality of pipes connected to each other in the housing, wherein
the components are provided at the outer surfaces of the positions where the components are mounted to the housing with reinforcing parts, the reinforcing parts being formed through injection molding of a resin material, and
the housing is provided with a plurality of bores corresponding to the reinforcing parts of the components, the bores being formed through injection molding of a resin material, the reinforcing parts of the components being fitted in the bores, respectively.

2. A method of manufacturing a hydraulic unit of an anti-lock brake system, the hydraulic unit comprising a housing having components that control braking oil pressure supplied to wheels of a vehicle, such as a plurality of valves, accumulators, and hydraulic pumps, mounted thereto, flow channels formed in the housing, the flow channels being connected between the components, and a plurality of pipes connected to each other in the housing, wherein the method comprises:
a reinforcing part manufacturing step of manufacturing reinforcing parts to be fitted on the outer surfaces of the components through injection molding;
a housing manufacturing step of manufacturing a housing provided with a plurality of bores having a size corresponding to that of the reinforcing parts through injection molding using a mold; and
a component mounting step of mounting components with the reinforcing parts to the housing.

3. The method according to claim 2, wherein the reinforcing part manufacturing step is carried out such that the reinforcing parts are formed while the components are placed in molds used to form the reinforcing parts, whereby the reinforcing parts are formed integrally with the components, respectively.

4. The method according to claim 2, wherein the reinforcing part manufacturing step comprises the sub-steps of:
separately forming the reinforcing parts using molds; and
fitting the reinforcing parts on the outer surfaces of the components, respectively.

5. The method according to claim 2, wherein the housing manufacturing step is carried out such that the bores and the flow channels are simultaneously formed.

6. The method according to claim 2, wherein the component mounting step is carried out such that bonding agents are applied to the outer surfaces of the reinforcing parts, and then the reinforcing parts are forcibly fitted into the bores of the housing, respectively.

7. The method according to claim 2, wherein the reinforcing part manufacturing step comprises the sub-steps of: forming thread parts at the outer surfaces of the reinforcing parts, and the housing manufacturing step comprises the sub-steps of: forming thread parts at the inner surfaces of the bores of the housing, the thread parts of the bores of the housing corresponding to those of the reinforcing parts, whereby the reinforcing parts are fitted into the bores of the housing by the thread engagement between the reinforcing parts and the bores of the housing.
